(19) United States
(12) Patent Application Publication
(10) Pub. No.: US 2026/0129290 A1
(43) Pub. Date: May 7, 2026

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: MANABU ABE, Tokyo (JP)

(21) Appl. No.: 19/350,622

(22) Filed: Oct. 6, 2025

(30) Foreign Application Priority Data
Nov. 1, 2024 (JP) 2024-193279

(51) Int. Cl. H04N 23/667; G01J 1/42; G01J 1/44; H04N 23/73

(52) U.S. Cl. CPC H04N 23/667; G01J 1/4204; G01J 1/44; H04N 23/73

(57) ABSTRACT

A control apparatus includes one or more memories storing instructions, and one or more processors that, upon execution of the instructions, operate to detect extraneous light, perform an imaging operation by synchronizing a light emission timing of a light emitter and an imaging timing of an imaging unit in accordance with a distance to an object, and change the imaging operation in accordance with a detection result of detecting the extraneous light.

### BACKGROUND

### Field of the Technology

The aspect of the disclosure relates to one or more embodiments of a control apparatus, an image pickup apparatus, a control method, and a storage medium.

### Description of the Related Art

Conventionally, on-board cameras (in-vehicle cameras) that perform range-gate control have been known. In such an on-board camera, during exposure, extraneous light (light irradiated from the outside, external irradiated light) such as headlights of an oncoming vehicle, taillamps or brake lamps of a preceding vehicle, may serve as a noise source, and thus it may be impossible to obtain a proper image. Japanese Patent Application Laid-Open No. 2006-339994 discloses a method of controlling a gain or shutter speed in a pixel range determined to have high luminance under extraneous light.

However, the method disclosed in Japanese Patent Application Laid-Open No. 2006-339994 cannot reduce the influence of the extraneous light itself, and thus has difficulty in acquiring a proper image in the presence of a large amount of extraneous light or near the extraneous light.

### SUMMARY

A control apparatus according to one aspect of the disclosure includes one or more memories storing instructions, and one or more processors that, upon execution of the instructions, operate to detect extraneous light, perform an imaging operation by synchronizing a light emission timing of a light emitter and an imaging timing of an imaging unit in accordance with a distance to an object, and change the imaging operation in accordance with a detection result of detecting the extraneous light. An image pickup apparatus having the above control apparatus also constitutes another aspect of the disclosure. A control method corresponding to the control apparatus and a storage medium storing a program that causes a computer to execute the above control method also constitute another aspect of the disclosure.

Further features of various embodiments of the disclosure will become apparent from the following description of embodiments with reference to the attached drawings. The following description of embodiments will be provided by way of example.

### BRIEF DESCRIPTION OF THE DRAWINGS

FIG. 1 illustrates an example configuration of a photoelectric conversion element according to this embodiment.

FIG. 2 illustrates an example configuration of a sensor substrate according to this embodiment.

FIG. 3 illustrates an example configuration of a circuit board according to this embodiment.

FIG. 4 illustrates an example configuration of pixels according to this embodiment.

FIG. 5 illustrates an example configuration of a count enable generator according to this embodiment.

FIG. 6 illustrates an equivalent circuit of a pixel portion and a signal processing circuit according to this embodiment.

FIG. 7 is a schematic diagram illustrating a relationship between an operation of an APD and its output signal according to this embodiment.

FIG. 8 is a block diagram of an imaging system according to this embodiment.

FIG. 9 illustrates a relationship among the propagation of radiation light from an IR light emitter and its reflected light, and an exposure timing of a camera according to this embodiment.

FIG. 10 is a timing chart for illustrating a control operation for obtaining a range-gate image per frame time according to this embodiment.

FIG. 11 is a chart illustrating a detection operation of extraneous light at an extraneous-light detecting pixel according to this embodiment.

FIG. 12 illustrates an extraneous light amount according to this embodiment.

FIG. 13 illustrates the cycle of extraneous light and the interstitial range-gate imaging operation timing according to this embodiment.

FIG. 14 is a flowchart of a range-gate imaging operation including an interstitial range-gate imaging operation according to this embodiment.

FIG. 15 is a flowchart illustrating the interstitial range-gate imaging operation according to this embodiment.

FIG. 16 illustrates a pixel area divided into a plurality of areas according to this embodiment.

FIGS. 17A, 17B, and 17C are schematic diagrams illustrating an example of an extraneous light amount obtained by summing extraneous light received by extraneous-light detecting pixels in each divided area according to this embodiment.

FIG. 18 is a flowchart illustrating the interstitial range-gate imaging operation using a plurality of extraneous lights according to this embodiment.

FIG. 19 is a flowchart illustrating the interstitial range-gate imaging operation using a plurality of extraneous lights according to a variation of this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. The disclosure is not limited to these embodiments. Corresponding elements in respective figures will be designated by the same reference numerals, and a duplicate description thereof will be omitted.

This embodiment relates to a control apparatus and an image pickup apparatus that perform range-gate imaging. The range-gate imaging is a method in which a distance range of an imaging target existing in front of the image pickup apparatus is set as a target distance and only an object in the range of the target distance is imaged. For example, pulsed light is emitted toward the front side of the image pickup apparatus at a predetermined cycle, and an image sensor inside the image pickup apparatus is exposed at a timing at which reflected light from the target distance can be imaged. Thereby, only an object existing in the range of the target distance can be clearly imaged. Hereinafter, such control will be referred to as range-gate control. The range-gate control can clearly image, for example, an object located at a predetermined distance even in bad weather.

### Example Configuration of Photoelectric Conversion Element

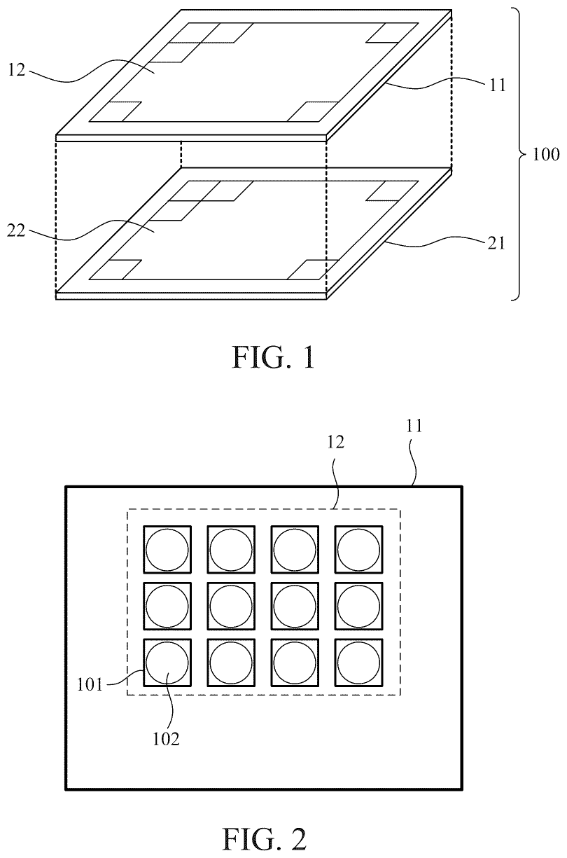

FIG. 1 illustrates an example configuration of a photoelectric conversion element (imaging unit) 100 according to this embodiment. In the following description, the photoelectric conversion element 100 is, for example, a photoelectric conversion element having a so-called stacking structure constituted by stacking two boards, namely a sensor substrate 11 and a circuit board 21, and electrically connecting them. However, this embodiment is not limited to this example but is also applicable to a so-called non-stacking structure in which components included in the sensor substrate 11 and components included in the circuit board 21 are disposed in the same semiconductor layer. The sensor substrate 11 includes a pixel area 12. The circuit board 21 includes a circuit area 22 configured to process a signal detected in the pixel area 12.

### Example Configuration of Sensor Substrate

FIG. 2 illustrates an example configuration of the sensor substrate 11. The pixel area 12 of the sensor substrate 11 includes a plurality of pixel portions 101 two-dimensionally disposed in row and column directions. Each pixel portion 101 includes a photoelectrical converter 102 including an avalanche photodiode (APD). The photoelectrical converter 102 functions as a sensor portion (sensor unit) configured to emit pulses in accordance with the reception of photons. The number of rows and the number of columns of the pixel array constituting the pixel area 12 are not particularly limited.

### Example Configuration of Circuit Board

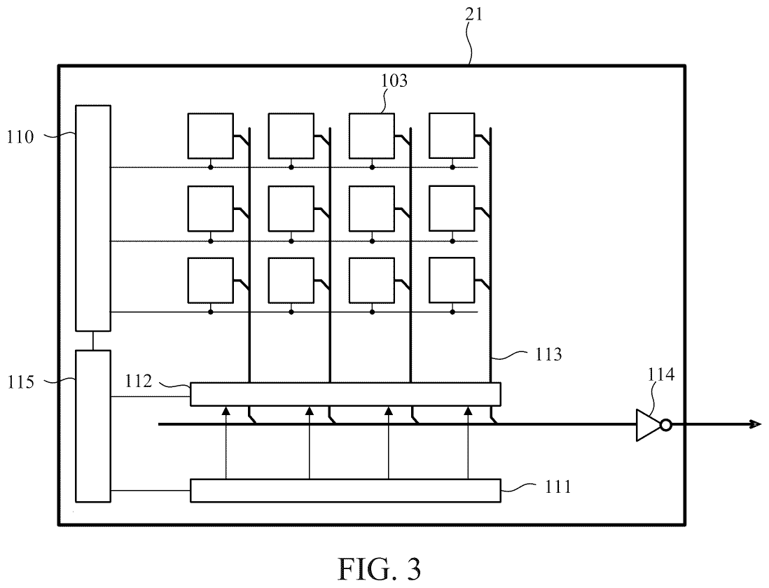

FIG. 3 illustrates an example configuration of the circuit board 21. The circuit board 21 includes signal processing circuits 103 configured to process electric charge photoelectrically converted at the photoelectric converters 102 illustrated in FIG. 2, a read circuit 112, a control pulse generator 115, a horizontal scanning circuit 111, a vertical signal line 113, a vertical scanning circuit 110, and an output circuit 114.

The vertical scanning circuit 110 receives a control pulse supplied from the control pulse generator 115 and sequentially supplies the control pulse to a plurality of pixels arrayed in the row direction. The vertical scanning circuit 110 employs a logic circuit such as a shift register or an address decoder.

A signal output from the photoelectrical converter 102 of each pixel is processed by the corresponding signal processing circuit 103. Each signal processing circuit 103 is provided with a counter, a memory, and the like, and digital values are held in the memory. To read signals from the memories of the respective pixels, in which digital signals are held, the horizontal scanning circuit 111 inputs a control pulse that sequentially selects each column to the signal processing circuits 103.

Signals are output from the signal processing circuits 103 of pixels on a row selected by the vertical scanning circuit 110 to the vertical signal line 113. The signals output to the vertical signal line 113 are output to the outside of the photoelectric conversion element 100 through the read circuit 112 and the output circuit 114. The read circuit 112 includes a plurality of buffers connected to the vertical signal line 113.

As illustrated in FIGS. 2 and 3, the plurality of signal processing circuits 103 are disposed in an area overlapping the pixel area 12 in a plan view. The vertical scanning circuit 110, the horizontal scanning circuit 111, the read circuit 112, the output circuit 114, and the control pulse generator 115 are disposed so as to overlap an area between the end of the sensor substrate 11 and the end of the pixel area 12 in a plan view. In other words, the sensor substrate 11 has the pixel area 12 and a non-pixel area disposed around the pixel area 12. The vertical scanning circuit 110, the horizontal scanning circuit 111, the read circuit 112, the output circuit 114, and the control pulse generator 115 are disposed in an area overlapping the non-pixel area in a plan view.

An arrangement of the vertical signal line 113, the read circuit 112, and the output circuit 114 is not limited to the example illustrated in FIG. 3. For example, the vertical signal line 113 may be disposed in the row direction, and the read circuit 112 may be disposed at an end to which the vertical signal line 113 extends. The signal processing circuits 103 do not necessarily need to be provided for all the photoelectrical converters 102, respectively, and one signal processing unit may be shared among a plurality of photoelectrical converters 102 to sequentially perform signal processing.

### Pixel Portion

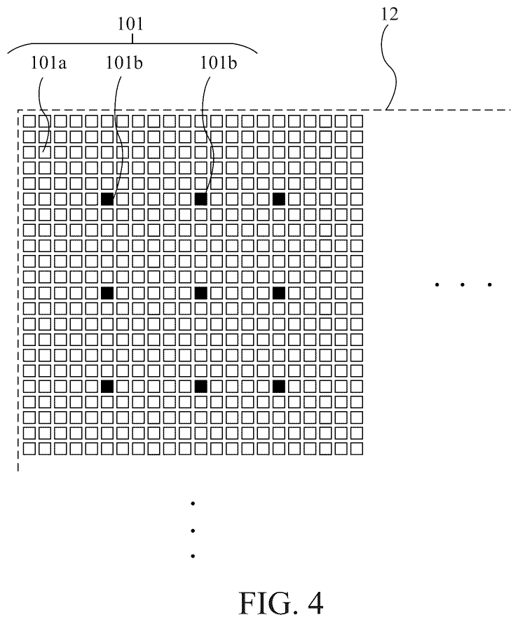

FIG. 4 illustrates an example configuration of each pixel portion 101 disposed in the pixel area 12. As illustrated in FIG. 4, according to this embodiment, each pixel portion 101 includes range-gate pixels (first pixels or first pixel portions) 101a and extraneous-light detecting pixels (second pixels or second pixel portions) 101b. The range-gate pixels 101a are pixels that perform exposure in the range-gate control to be described later. The extraneous-light detecting pixels 101b are pixels that perform extraneous light detecting to be described later. The number of the extraneous-light detecting pixels 101b is smaller than that of the range-gate pixels 101a (the density of the extraneous-light detecting pixels 101b is lower than that of the range-gate pixels 101a). As illustrated in FIG. 4, according to this embodiment, the extraneous-light detecting pixels 101b are disposed in the pixel area 12 at constant intervals, and the remaining pixels other than those are configured as the range-gate pixels 101a. However, in this embodiment, disposition of the extraneous-light detecting pixels 101b is not limited to the disposition illustrated in FIG. 4 but may be any other disposition with which the extraneous light detecting to be described later is possible in the pixel area 12.

### Count Enable Generator

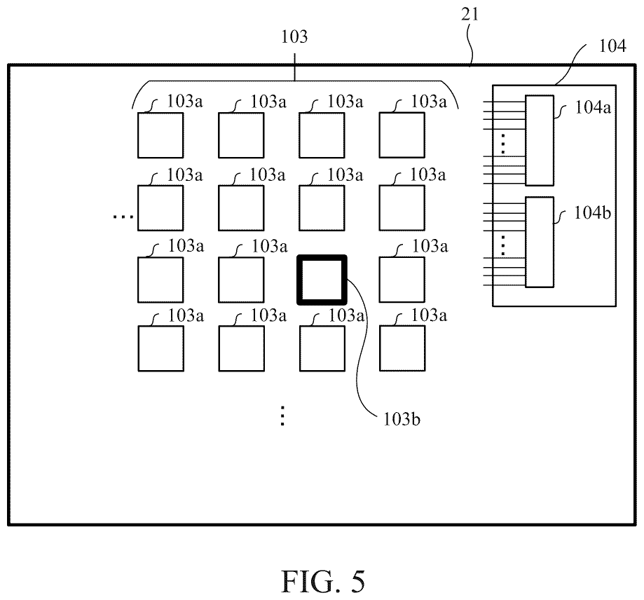

FIG. 5 illustrates an example configuration of a count enable generator 104 configured to generate signals to be supplied to the signal processing circuits 103 described above with reference to FIG. 3. As illustrated in FIG. 5, each signal processing circuit 103 includes a range-gate signal processing circuit 103a and an extraneous-light detecting signal processing circuit 103b. The range-gate signal processing circuit 103a is a signal processing circuit that manages a signal entering the corresponding range-gate pixel 101a and photoelectrically converted. The extraneous-light detecting signal processing circuit 103b is a signal processing circuit that manages a signal entering the corresponding extraneous-light detecting pixel 101b and photoelectrically converted. In FIG. 5, a block of each extraneous-light detecting signal processing circuit 103b is illustrated with a thick line.

The count enable generator 104 generates count enable signals to be supplied to counters inside the signal processing circuits 103. The count enable signals are signals for controlling the enabling and disabling of the counters inside the signal processing circuits 103. The count enable generator 104 is configured to generate different signals respectively for the range-gate signal processing circuits 103a and the extraneous-light detecting signal processing circuits 103b. More specifically, the count enable generator 104 includes a first count enable generator (range-gate count enable generator) 104a and a second count enable generator (extraneous light detecting count enable generator) 104b. The first count enable generator 104a generates count enable signals to be supplied to the range-gate signal processing circuits 103a. The second count enable generator 104b generates count enable signals to be supplied to the extraneous-light detecting signal processing circuits 103b. In FIG. 5, connections between the signal processing circuits 103 and the count enable generator 104 are omitted.

### Signal Processing Circuit

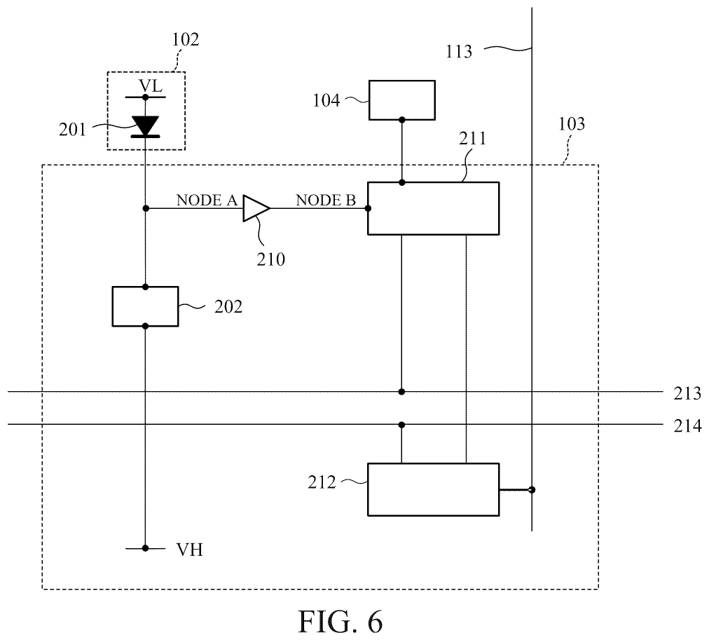

FIG. 6 illustrates an equivalent circuit of each pixel portion 101 illustrated in FIGS. 2 and 3 and the signal processing circuit 103 corresponding to the pixel portion 101. An APD 201 included in the photoelectric converter 102 generates electric charge pairs in accordance with incident light by photoelectric conversion. One of two nodes of the APD 201 is connected to a power source line to which drive voltage VL (first voltage) is supplied. The other of the two nodes of the APD 201 is connected to a power source line to which drive voltage VH (second voltage) higher than the voltage VL is supplied.

In FIG. 6, one node of the APD 201 is an anode, and the other node of the APD is a cathode. A reverse bias voltage that causes the APD 201 to perform an avalanche multiplication operation is supplied to the anode and cathode of the APD 201. By supplying such voltage, the electric charge generated by incident light causes avalanche multiplication, and avalanche current is generated.

In a case where reverse bias voltage is supplied, there are a Geiger mode in which the anode-cathode voltage difference is greater than breakdown voltage, and a linear mode in which the anode-cathode voltage difference is in the vicinity of or lower than the breakdown voltage. An APD operated in the Geiger mode is referred to as an SPAD. In the case of the SPAD, for example, the voltage VL (first voltage) is −30 V, and the voltage VH (second voltage) is 1 V.

Each signal processing circuit 103 includes a quenching element 202, a waveform shaping unit 210, a counter circuit (counter unit) 211, and a memory circuit (memory) 212. The quenching element 202 is connected to the power source line to which the drive voltage VH is supplied and one of the anode and cathode of the APD 201.

The quenching element 202 functions as a load circuit (quenching circuit) at signal multiplication by avalanche multiplication and serves to suppress voltage supplied to the APD 201 so as to suppress the avalanche multiplication (quenching operation). Moreover, the quenching element 202 serves to return voltage supplied to the APD 201 to the drive voltage VH by flowing current corresponding to a voltage drop caused by the quenching operation (recharge operation).

FIG. 6 illustrates an example in which the signal processing circuit 103 includes the waveform shaping unit 210, the counter circuit 211, and the memory circuit 212 in addition to the quenching element 202. The waveform shaping unit 210 shapes a voltage change of the cathode of the APD 201, which is obtained upon detection of a photon, and outputs a pulse signal. For example, an inverter circuit is used as the waveform shaping unit 210. In the example illustrated in FIG. 6, one inverter is used as the waveform shaping unit 210, but a circuit in which a plurality of inverters are connected in series may be used or any other circuit having a waveform shaping effect may be used.

The counter circuit 211 counts the number of pulses output from the waveform shaping unit 210 and holds a count value. When a control pulse RES is supplied through a drive line 213, a signal held by the counter circuit 211 is reset. The counter circuit 211 generates a signal based on the difference of the count value between the start and end of accumulation duration.

A count enable signal (not illustrated in FIG. 6) is supplied to the counter circuit 211 from the count enable generator 104 described above with reference to FIG. 5. In an interval in which the count enable signal is “High,” the counter circuit 211 counts the number of pulses output from the waveform shaping unit 210, and in an interval in which the count enable signal is “Low,” the counter circuit 211 holds the count value without counting the number of pulses. Thereby, for example, in a case where the count enable generator 104 is a circuit that operates at a clock frequency of 100 MHz, the count enable signal can be controlled to be “High” and “Low” (enable/disable control) in units of 10 nsec of a clock cycle. Since the number of pulses output from the photoelectrical converter 102 in accordance with a photon reception frequency is counted only during a count enable duration, the count enable duration of the number of pulses can be referred to as an exposure duration of the pixel portion 101. Thus, according to this embodiment, switching control of whether to perform exposure or not can be controlled in units of 10 nsec.

Moreover, as illustrated in FIG. 5, the count enable signal can be generated as different signals for the range-gate signal processing circuit 103a and the extraneous-light detecting signal processing circuit 103b by the count enable generator 104. According to this embodiment, mutually different count enable signals are generated for the range-gate signal processing circuit 103a and the extraneous-light detecting signal processing circuit 103b. Details of the generated signals will be described later by using a timing chart.

A control pulse SEL is supplied to the memory circuit 212 from the vertical scanning circuit 110 illustrated in FIG. 3 through a drive line 214 (not illustrated in FIG. 3) illustrated in FIG. 6 to switch electrical connection and disconnection between the counter circuit 211 and the vertical signal line 113. The memory circuit 212 functions as a memory that temporarily stores the counter count value, and outputs an output signal from the counter circuit 211 of the pixel to the vertical signal line 113.

A switch such as a transistor may be disposed between the quenching element 202 and the APD 201 and between the photoelectrical converter 102 and the signal processing circuit 103 to switch the electrical connection. Similarly, the supply of the voltage VH or the voltage VL supplied to the photoelectrical converter 102 may be electrically switched by using a switch such as a transistor.

### Operation of APD

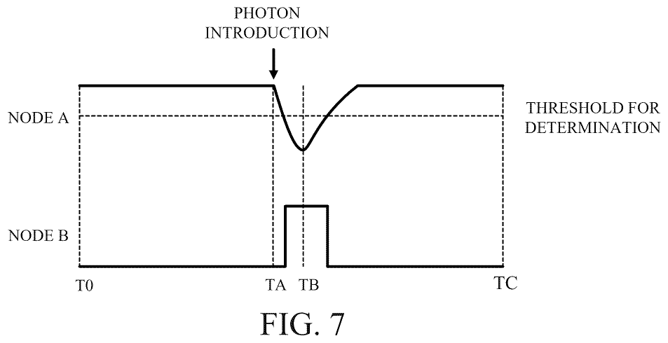

FIG. 7 is a schematic diagram illustrating the relationship between an operation of the APD 201 and its output signal. The input side of the waveform shaping unit 210 is node A, and its output side is node B. Between time point ta and time point tb, the potential difference of VH-VL is applied to the APD 201. When a photon is incident on the APD 201 at time point ta, avalanche multiplication occurs in the APD 201, avalanche multiplication current flows to the quenching element 202, and the voltage of node A decreases.

When the voltage drop amount further increases and the potential difference applied to the APD 201 decreases, avalanche multiplication of the APD 201 stops as at time point tb and the voltage level of node A does not decrease below a certain value. Thereafter, between time point tb and time point tc, current that compensates for voltage drop from the voltage VL flows to node A, and node A settles to the original potential level at time point tc. At this time, a part of an output waveform at node A, which exceeds a certain threshold, is waveform-shaped by the waveform shaping unit 210 and output as a pulse signal at node B.

### Imaging System

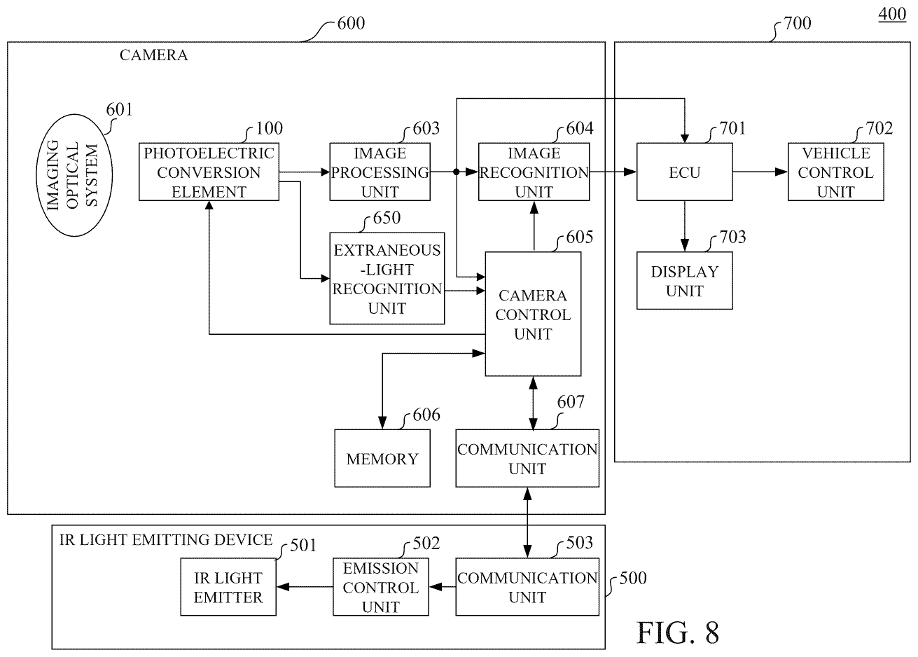

An imaging system 400 according to this embodiment will be described below. FIG. 8 is a block diagram of the imaging system 400. According to this embodiment, the imaging system 400 includes an IR light emitting device 500, a camera (image pickup apparatus, control apparatus) 600, and a movable unit 700.

Some of the functional blocks illustrated in FIG. 8 are implemented by causing a non-illustrated computer included in the IR light emitting device 500, the camera 600, and the movable unit 700 to execute a computer program stored in an unillustrated memory as a storage medium. However, this embodiment is not limited to this example, and part or whole of it may be implemented by hardware. The hardware may be a dedicated circuit (ASIC), a processor (reconfigurable processor or DSP), or the like. The functional blocks illustrated in FIG. 8 do not necessarily need to be incorporated in the same housing and may be constituted by separate apparatuses connected to each other through a signal path.

The camera 600 includes the photoelectric conversion element 100 described above with reference to FIGS. 1 to 7, an imaging optical system 601, an image processing unit 603, an image recognition unit 604, a camera control unit (control unit, one or more processors) 605, a memory (one or more memories) 606, a communication unit 607, and an extraneous-light (EL) recognition unit 650. The photoelectric conversion element 100 includes an avalanche photodiode (APD) described above with reference to FIGS. 1 to 6 for photoelectrically converting an optical image.

In this embodiment, the camera 600 and the IR light emitting device 500 are mounted on the movable unit 700. A camera unit constituted by a set of the imaging optical system 601 and the photoelectric conversion element 100 is configured to be capable of imaging in at least one of directions in front of, behind, and beside the movable unit 700, for example. A plurality of camera units may be provided on the movable unit 700.

The image processing unit 603 performs various kinds of image processing on an image signal acquired by the photoelectric conversion element 100. According to this embodiment, the image processing unit 603 performs image processing such as black level correction, gamma curve adjustment, noise reduction, digital gain adjustment, demosaic processing, and data compression on signals from the range-gate pixels 101a, thereby generating definitive image signals.

Output signals from the image processing unit 603 are supplied to the image recognition unit 604, an electric control unit (ECU) 701 of the movable unit 700, and a camera control unit 605. The image recognition unit 604 performs processing that recognizes objects such as persons and vehicles in the surroundings by performing image recognition based on the image signals. This recognition processing can employ deep learning. For example, You Only Look Once (YOLO) may be used as the deep learning, which is easy to train and enables fast detection. As other deep learning, Single Shot MultiBox Detector (SSD), Faster Regional Convolution Neural Network (R-CNN), Fast R-CNN, R-CNN, and the like may be used.

In this embodiment, the image recognition unit 604 calculates a distance to a recognized object (distance measurement). One of the distance measurement methods is, for example, a method of estimating the distance by using deep learning. As an example, there is a method of calculating a distance value by analyzing information such as the blurring of an image of a detected object with deep learning. As another method, the image pickup apparatus may be a stereo camera, and a method of measuring the distance by using the principle of triangulation may be employed. The result of recognition by the image recognition unit 604 is output to the ECU 701 at a later stage.

In this embodiment, the movable unit 700 is described by taking an automobile as an example, but is not limited to this example. The movable unit 700 may be any movable unit that is movable, such as an aircraft, a train, a ship, a drone, an AGV, or a robot.

The extraneous-light recognition unit 650 recognizes irradiation light having a cycle, which is irradiated from outside, based on signals obtained from the extraneous-light detecting pixels 101b in the photoelectric conversion element 100. Hereinafter, irradiation light irradiated from outside is referred to as extraneous light. That is, the extraneous-light recognition unit 650 constitutes a detector that detects extraneous light irradiated from outside together with the extraneous-light detecting pixels 101b.

In this embodiment, extraneous light is IR light as cyclic light (light of a first light amount in a first duration and light of a second light amount in a second duration) having a particular cycle (sum of the first duration and the second duration). An example of extraneous light is a headlight using an LED light source mounted on an automobile and having a cycle based on PWM control. Extraneous light is light not caused by light emission from an IR light emitter 501 to be described later. The extraneous-light recognition unit 650 monitors extraneous light, and when extraneous light is detected, the extraneous-light recognition unit 650 analyzes its cycle and specifies its cycle and timing. Thereafter, the cycle and the timing are output to the camera control unit 605. The camera control unit 605 acquires the cycle and timing of specified extraneous light. The camera control unit 605 performs an imaging operation by synchronizing the light emission timing of the IR light emitter 501 to be described later and an imaging timing of the photoelectric conversion element 100 in accordance with the distance (target distance) to an object. In this embodiment, the camera control unit 605 changes the imaging operation in accordance with a detection result obtained by the extraneous-light recognition unit 650. The imaging operation includes a series of operations that process image data output from the photoelectric conversion element 100 upon exposure.

The camera control unit 605 includes a CPU as a computer and a memory storing computer programs and controls components of the camera 600 by causing the CPU to execute the computer programs stored in the memory. The camera control unit 605 functions as a control unit and controls the length of an exposure duration of each frame in the photoelectric conversion element 100, the timing of a control signal, and the like through the count enable generator 104 of the photoelectric conversion element 100, for example. These kinds of control are based on the target distance (distance to an object) of a range-gate image that is imaged by the range-gate control to be described later.

More specifically, the camera control unit 605 transmits a reference signal that is repeatedly output to the count enable generator 104 at predetermined intervals. The count enable generator 104 generates a signal that repeats enabling and disabling at predetermined timings with the reference signal as a timing reference. The count enable generator 104 can set a duration from the reference signal until enabling of counting, an enable width, a disable width, a repetition cycle of enabling and disabling, a repetition number, and the like. As the camera control unit 605 sets predetermined values to them through control signals, a count enable signal is input to the counter circuit 211 at predetermined timings with the reference signal as a reference, and the exposure duration of each pixel is controlled.

As described above with reference to FIG. 5, the count enable generator 104 can generate mutually different count enable signals for the range-gate signal processing circuits 103a and the extraneous-light detecting signal processing circuits 103b.

The camera control unit 605 transmits the same signal as the reference signal to the IR light emitting device 500 as well through the communication unit 607. In this manner, the same reference signal transmitted to the photoelectric conversion element 100 is also transmitted to the IR light emitting device 500, and the IR light emitting device 500 executes light emission control with the reference signal as a reference. Thereby, the timing of exposure inside the photoelectric conversion element 100 and the timing of light emission from the IR light emitting device 500 can be synchronized (synchronization control).

In a case where extraneous light is detected by using the extraneous-light recognition unit 650, the camera control unit 605 generates count enable signals as described above based on information on the extraneous light output from the extraneous-light recognition unit 650, and performs exposure of the range-gate pixels 101a. Details of an operation in a case where extraneous light is detected will be described later.

The memory 606 includes, for example, a recording medium such as a memory card or a hard disk drive and can store and read image signals and instructions to be executed by the camera control unit 605. The communication unit 607 includes a wireless or wired interface, outputs generated image signals to the outside of the camera 600, and receives various signals from the outside. In this embodiment, the communication unit 607 is connected to a communication unit 503 of the IR light emitting device 500 and serves to transmit the reference signal and transmit control commands from the camera control unit 605 to the IR light emitting device 500.

The IR light emitting device 500 includes the IR light emitter 501, an emission control unit 502, and the communication unit 503. The IR light emitter 501 is disposed, for example, on the front side of the movable unit 700 and includes a lens and a light emitter constituted by a near-infrared LED. Light emitter outputs pulsed light during a predetermined light emission time in accordance with a pulse signal output from the emission control unit 502.

The emission control unit 502 receives the reference signal transmitted from the camera control unit 605 of the camera 600 through the communication unit 503, generates a pulse signal at predetermined timings with the reference signal as a reference, and outputs the pulse signal to the IR light emitter 501. The emission control unit 502 can set a duration from the reference signal until outputting a pulse, a pulse outputting width, a non-pulse-outputting width, a repetition cycle from pulse outputting to the next pulse outputting, a repetition number, and the like. As the camera control unit 605 sets predetermined values to the emission control unit 502 through the communication unit 607 and the communication unit 503, a pulse signal is output to the IR light emitter 501 at predetermined timings with the reference signal as a reference, and the light emission duration of the IR light emitting device 500 is controlled. Thus, the light emission of the emission control unit 502 is controlled by using, as a reference, the same signal as the reference signal input to the photoelectric conversion element 100.

The communication unit 503 communicates with the communication unit 607 in the camera 600, receives setting information and the reference signal from the camera control unit 605 to the emission control unit 502, and transmits the setting information and the reference signal to the emission control unit 502.

The ECU 701 includes a CPU as a computer and a memory storing computer programs and controls components of the movable unit 700 by causing the CPU to execute the computer programs stored in the memory. Output signals from the ECU 701 are supplied to a vehicle control unit 702 and a display unit 703. The vehicle control unit 702 functions as a movement control unit for performing driving, stopping, direction control, and the like of a vehicle as the movable unit 700 based on an output signal from the ECU 701. The display unit 703 functions as a display unit, includes a display element such as a liquid crystal device or an organic EL, and is mounted on the movable unit 700.

In this embodiment, the ECU 701 receives information on a recognition result from the image recognition unit 604 and can execute stop control (such as automatic brake) of the vehicle in accordance with the contents of the recognition result. The ECU 701 receives an image from the image processing unit 603 and transmits the image to the display unit 703 together with the recognition result.

Based on the output from the ECU 701, the display unit 703 displays an image acquired by the photoelectric conversion element 100, the recognition result from the image recognition unit 604, and various kinds of information on the traveling state of the vehicle and the like to a driver of the movable unit 700 by using, for example, a GUI.

The image processing unit 603, the image recognition unit 604, and the like illustrated in FIG. 8 do not necessarily need to be mounted on the movable unit 700. They may be provided in, for example, an external terminal provided separately from the movable unit 700 to remotely control the movable unit 700 or monitor traveling of the movable unit.

### Range-Gate Control

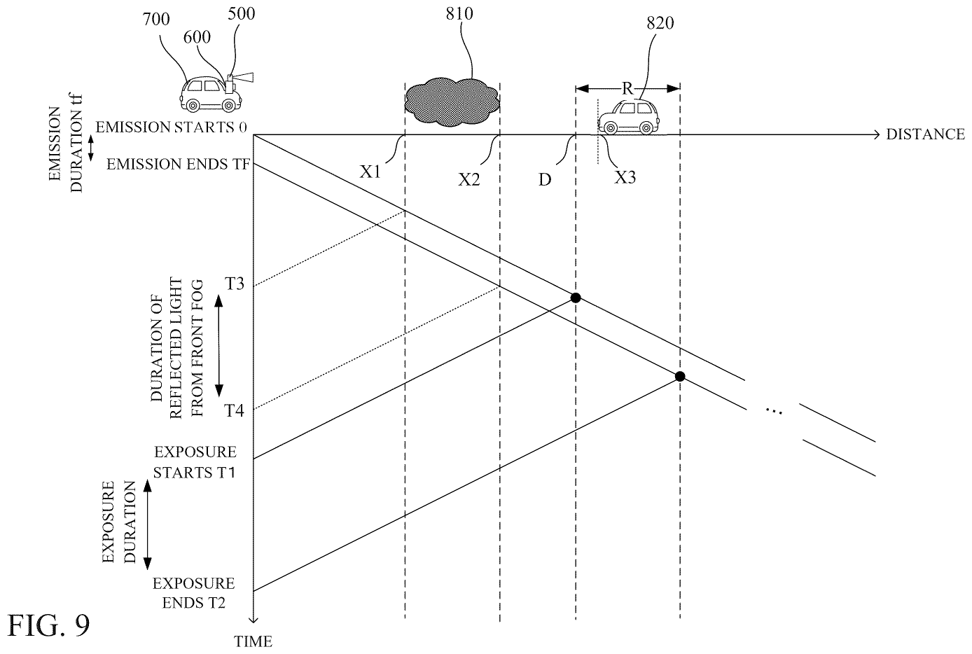

FIG. 9 illustrates a relationship between propagation of radiation light from the IR light emitting device 500 and its reflected light, and the exposure timing of the camera 600. FIG. 9 illustrates a method of acquiring an image (range-gate image) obtained by imaging an object existing in the range of the target distance by performing control (range-gate control) that synchronizes the light emission timing and the exposure timing in accordance with the target distance. A camera configured to acquire a target distance image by the range-gate control is referred to as a range-gate camera. In FIG. 9, the horizontal axis represents a distance, and the vertical axis represents time.

First, the horizontal axis in FIG. 9 will be described below. The position of the movable unit 700 is set to zero (reference position), a fog 810 exists between a distance x1 and a distance x2, and a vehicle 820 exists at a distance x3. In FIG. 9, in the range-gate control, a position at distance D is set as a starting point, and a range-gate image is acquired in the range of range width R from the starting point. In this case, range width R is a target distance range to be imaged. At this moment, the vehicle 820 exists in the range of range width R.

The vertical axis in FIG. 9 will be described next. Time 0 is the start timing of light emission from the IR light emitting device 500, and time tf is the end timing of the light emission. At this time, the light emission duration is tf. The position at distance D is set as a starting point, the start time of exposure when a range-gate image is acquired in the range of range width R from the starting point is set as time t1, and the end time of the exposure is set as time t2. Time t1 is a timing at which radiation light radiated from the IR light emitting device 500 at time 0 is returned to the camera 600 as reflected light from distance D. Time t2 is a timing at which radiation light radiated from the IR light emitting device 500 at time tf returns to the camera 600 as reflected light from a distance (position) that has advanced by range width R from distance D. Time t3 is a timing at which first reflected light by the fog 810 returns to the camera 600. Time t4 is a timing at which the last reflected light by the fog 810 returns to the camera 600.

In the range-gate control, exposure is not performed during the duration from time t3 at which reflected light from the fog 810 arrives at the camera 600 to time t4, and exposure is performed only during the duration from time t1 at which reflected light corresponding to range width R from distance D arrives at time t2. Thereby, a clear image of the vehicle 820 with reduced influence of the fog 810 can be acquired.

A description will be given of a time for reflected light from a target object existing at distance x to return to the camera 600. Time tr is set to be a timing at which radiation light emission of which starts at time 0, returns to an imaging unit (the photoelectric conversion element 100) of the camera 600 as reflected light after being incident on the target object existing at distance x. The relationship between timing time tr at which the reflected light returns and distance x to the imaging target object can be expressed below:

$$Time tr = 2 \times light speed c ( approximately 3 \times 10 \hat{} 8 [ m / s ] ) \qquad ( 1 )$$

As illustrated in FIG. 9, in a case where the imaging range is range width R from distance D, time t1 as the exposure timing at the starting point of range width R can be obtained from Equation (2) by substituting distance D into distance x in Equation (1) described above.

$$Time t 1 = 2 D / light speed c \qquad ( 2 )$$

Time t2 as the exposure timing at the end point of range width R can be obtained from Equation (3) below by substituting distance D+range width R into distance x in Equation (1) described above and adding time tf.

$$Time t 2 = tf + 2 ( D + R ) / light speed c \qquad ( 3 )$$

In this manner, in this embodiment, time tr from light emission to exposure is controlled in accordance with distance x (the target distance) to an imaging target object. Thereby, even when the fog 810 or the like exists between the camera 600 and an object (the vehicle 820) at the target distance, it is possible to achieve the range-gate control that can clearly image the object at the target distance.

### Cycle of Range-Gate Operation

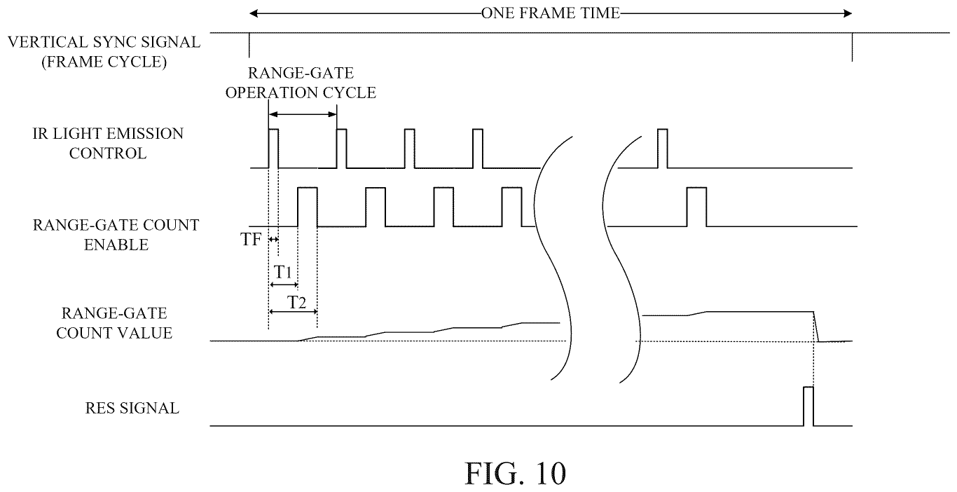

FIG. 10 is a timing chart for the description of a control operation for obtaining a range-gate image per frame time. In this embodiment, the range-gate image is obtained by generating the IR image through exposure in synchronization with light emission from the IR light emitting device 500. The IR image generation is performed at the range-gate pixels 101a.

In FIG. 10, a vertical synchronizing signal indicates a frame cycle of imaging, and the duration between a “Low” pulse and the next “Low” pulse is one frame time. The waveform of a range-gate count enable indicates the timings of start and end of counting the number of photons in a count enable signal output from the first count enable generator 104a. A range-gate count value indicates the state of increase and decrease in the count of photons in the counter circuit 211 of a range-gate pixel 101a. IR light emission control indicates the light emission timing of the IR light emitting device 500. The range-gate count value indicates the state of increase and decrease in the count of photons in the counter circuit 211 of the range-gate pixel 101a. A RES signal is a control pulse supplied to the counter circuit 211 through the drive line 213, and a held count value is reset by the pulse.

First, the range-gate control for obtaining a range-gate image will be described below. In this control, the light emission duration of IR light is controlled in a pulsed manner by the emission control unit 502, and counting of the number of photons is performed only for IR light reflected from a particular range.

A light emission duration from start to end of light emission is tf, a time from start of light emission to start of counting the number of photons is t1, and a time from start of light emission to end of counting the number of photons is t2. In this case, time t1 indicates a duration in which light arrives at a particular range after the start of light emission and reflected light returns to the camera 600. Time from t1 to t2 is a duration in which the number of photons of reflected light in the particular range is counted, and is a duration from start to end of a range-gate count enable.

In the duration from start to end of a range-gate count enable, the range-gate count value increases in accordance with the number of photons. To correctly perform the range-gate control, it is needed to synchronize the timings of start and end of light emission and the timings of start and end of exposure in accordance with the range of a predetermined target distance. In this embodiment, the camera control unit 605 achieves the synchronization by transmitting the same reference signal to the count enable generator 104 and the emission control unit 502.

The duration from start of light emission to start of the next light emission as indicated by the IR light emission control on the timing chart is a range-gate operation cycle. While the range-gate count value, which is obtained during one range-gate operation cycle is held, the range-gate count value is added in the next range-gate operation cycle. The duration from light emission to the next light emission is set with a time until reflected light sufficiently attenuates and stops returning to the camera 600 as a reference.

As illustrated in FIG. 10, the range-gate operation cycle is repeated a set number of times during one frame time. Information on the range-gate count value added last during one frame time is transferred from the counter circuit 211 to the memory circuit 212, and thereafter, the range-gate count value is reset by the RES signal. In such a range-gate control, since the exposure duration is synchronized with light emission from the IR light emitting device 500, it is possible to obtain a clear IR image for a targeted range even under bad weather such as fog.

The method of acquiring a range-gate image based on the range-gate control is described above. Hereinafter, an operation that acquires a range-gate image based on the range-gate control is referred to as a range-gate imaging operation. In this embodiment, a pixel for acquiring a range-gate image is a range-gate pixel 101a as described above.

### Interstitial Range-Gate Imaging Operation

In the range-gate imaging operation, in order to obtain a clear image, an image may be acquired while extraneous light as a noise source is excluded (reduced) as much as possible. Thus, in a case where extraneous light having a particular cycle is detected, this embodiment performs an interstitial range-gate imaging operation to be described later in order to perform the range-gate imaging operation in a state in which influence of the extraneous light is reduced. A description will now be given of a method of detecting extraneous light having a particular cycle and of specifying the cycle, and the interstitial range-gate imaging operation when the cycle is specified.

### Extraneous Light Detection and Cycle Analysis

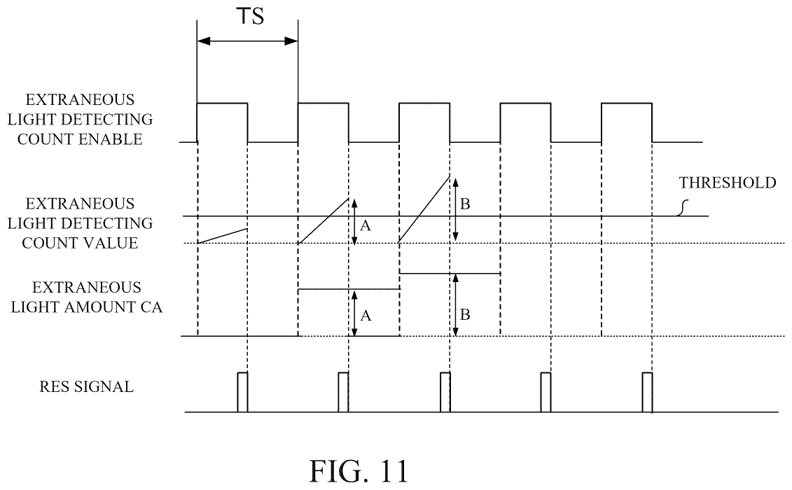

A description will now be given of extraneous light detection and cycle analysis. FIG. 11 is a chart illustrating a detection operation of extraneous light at each extraneous-light detecting pixel 101b. A description will now be given, as an example, of an operation at one of the plurality of extraneous-light detecting pixels 101b.

In FIG. 11, the waveform of a count enable for the extraneous light detection indicates the timings of start and end of counting the number of photons in a count enable signal output from the second count enable generator 104b, and its cycle is Ts. A count value for the extraneous light detection indicates the state of increase and decrease (temporal change in the number of photons) in the count of photons at the counter circuit 211 of the extraneous-light detecting pixel 101b.

The RES signal is a control pulse supplied to the counter circuit 211 through the drive line 213, and a held count value for the extraneous light detection is reset by the pulse. An extraneous light amount Ca indicates, in the count value for the extraneous light detection, a maximum value of the count value for the extraneous light detection, which exceeds a set threshold in each cycle Ts, and indicates the maximum value when the count value exceeds the threshold, and zero when the count value does not exceed the threshold. As illustrated in FIG. 11, the extraneous light amount Ca is A in a case where the count value for the extraneous light detection exceeds the threshold and is counted up to A, and similarly, and the extraneous light amount Ca is B in a case where the count value for the extraneous light detection exceeds the threshold and is counted up to B. The extraneous light amount Ca indicates zero in a case where the count value for the extraneous light detection is equal to or smaller than the threshold.

When the detection operation of extraneous light is started, the count value for the extraneous light detection increases in accordance with the number of photons during the duration of a waveform by a count enable signal output from the second count enable generator 104b, and is reset by the RES signal. While light is irradiated, the number of photons exceeding the threshold is indicated as the extraneous light amount Ca in accordance with the light amount. That is, the number of photons irradiated exceeding the threshold can be detected for each cycle Ts. The threshold according to this embodiment is set to be a value larger than the light amount of reflected light, which is assumed based on the light amount of radiation light radiated from the IR light emitting device 500. This makes it possible to detect extraneous light, which is light stronger than reflected light necessary for range-gate image acquisition. However, setting of the threshold is not limited to this example but only needs to allow detecting of a light amount having influence on an IR image to be acquired. Thus, extraneous light having a light amount strong enough to affect the IR image acquisition can be detected.

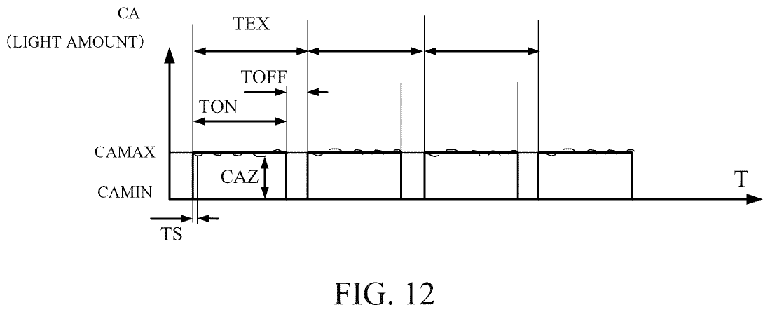

FIG. 12 is a diagram continuously illustrating the value of the extraneous light amount Ca in FIG. 11, and schematically illustrates a case where the extraneous light amount Ca has a particular cycle. It can be understood that the extraneous light amount Ca repeats, in a cycle Tex, an extraneous light amount maximum value Camax (second light amount) with which the light amount is maximum during a duration Ton (second duration), and an extraneous light amount minimum value Camin (first light amount) with which the light amount is minimum during a duration Toff (first duration).

In FIG. 12, the extraneous light amount minimum value Camin (first light amount) indicates zero. Since the frequency of a light-emitting LED typically used for extraneous light is 400 Hz or less and its cycle is 2.5 ms or more, the cycle Ts In this embodiment is assumed to be 100 μsec approximately. The same cycle Tex and durations Ton and Toff are detected for the extraneous light amount Ca at each extraneous-light detecting pixel 101b where extraneous light is detected. Among the extraneous-light detecting pixels 101b, the value of the extraneous light amount maximum value Camax is different but the duration Ton, the duration Toff, and the cycle Tex are the same. Even within one extraneous-light detecting pixel 101b, the extraneous light amount maximum value Camax increases and decreases with temporal change in the photon amount of extraneous light (temporal change in the number of photons). In this manner, the extraneous-light recognition unit 650 recognizes extraneous light having the particular cycle Tex and outputs the duration Ton, duration Toff, and its cycle Tex to the camera control unit 605. The difference between the extraneous light amount maximum value Camax (second light amount) and the extraneous light amount minimum value Camin (first light amount) is referred to as an extraneous light amount difference Caz.

### Interstitial Range-Gate Imaging Operation

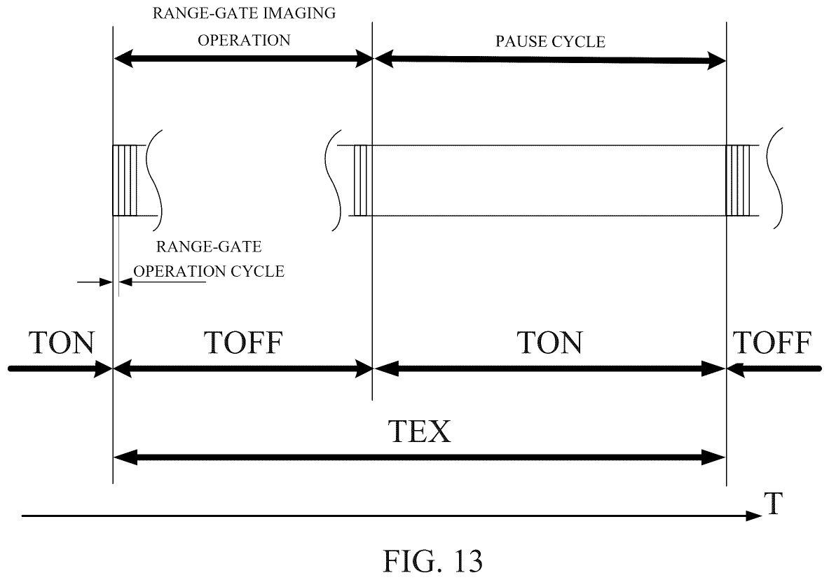

The interstitial range-gate imaging operation will be described next. FIG. 13 illustrates the cycle of recognized extraneous light and the timing of the interstitial range-gate imaging operation in FIG. 12. In FIG. 13, the horizontal axis represents time.

As illustrated in FIG. 13, in this embodiment, the camera control unit 605 performs the range-gate imaging operation during the duration Toff so as to reduce influence of extraneous light. More specifically, the range-gate imaging operation is not performed during the duration Ton in which extraneous light exceeding a threshold beyond which IR image acquisition is affected is irradiated, and the range-gate imaging operation is performed during the duration Toff in which extraneous light is not irradiated. More specifically, the duration Toff is predicted from the cycle Tex based on extraneous light information transferred from the extraneous-light recognition unit 650 to the camera control unit 605. Then, the timing of IR light emission, the timing of exposure, and the number of repetitions of the range-gate operation cycle, which can be performed during the duration Toff at the target distance, are calculated, and the processes are executed. In this embodiment, execution of the range-gate imaging operation during the duration Toff but not during the duration Ton is referred to as the interstitial range-gate imaging operation.

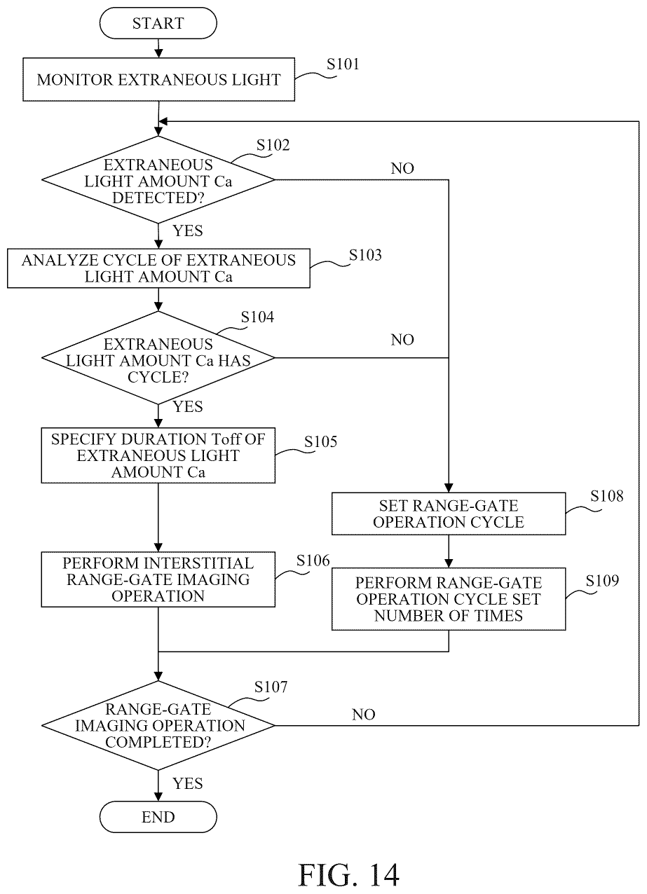

The range-gate imaging operation including the interstitial range-gate imaging operation will be described next. FIG. 14 is a flowchart illustrating the range-gate imaging operation including the interstitial range-gate imaging operation according to this embodiment.

The flow starts when the range-gate imaging operation is started. First in step S101, the extraneous-light recognition unit 650 monitors extraneous light. Next, in step S102, the extraneous-light recognition unit 650 determines whether the extraneous light amount Ca is detected. In a case where the extraneous light amount Ca is detected, the flow proceeds to step S103. In a case where the extraneous light amount Ca is not detected, the flow proceeds to step S108.

In step S103, the extraneous-light recognition unit 650 analyzes the cycle of the extraneous light amount Ca. Next, in step S104, the extraneous-light recognition unit 650 determines whether the extraneous light amount Ca has a cycle. In a case where it is determined that the extraneous light amount Ca has a cycle, the flow proceeds to step S105. In step S105, the extraneous-light recognition unit 650 specifies the duration Toff and the cycle Tex with which the light amount of the extraneous light amount Ca is minimum. Next, in step S106, the extraneous-light recognition unit 650 performs the interstitial range-gate imaging operation during the specified duration Toff.

On the other hand, in a case where it is determined that the extraneous light amount Ca does not have a cycle in step S104, the flow proceeds to step S108. In step S108, the camera control unit 605 sets setting values for the range-gate operation cycle based on the target distance. Next, in step S109, the camera control unit 605 repeats the range-gate operation cycle a set number of times.

In step S107, the camera control unit 605 determines whether the range-gate imaging operation has been completed. In a case where the range-gate imaging operation has completed, the flow ends. In a case where the range-gate imaging operation has not yet completed, the flow returns to step S102.

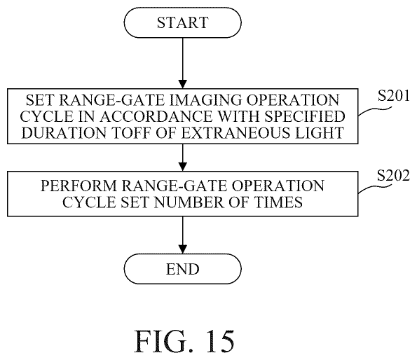

The interstitial range-gate imaging operation will be described next. FIG. 15 is a flowchart illustrating the interstitial range-gate imaging operation. The flow starts when the interstitial range-gate imaging operation starts. First in step S201, the camera control unit 605 sets setting values for performing the range-gate operation cycle based on the target distance so that the range-gate imaging operation can be performed during the duration Toff specified by the extraneous-light recognition unit 650. Next, in step S202, the camera control unit 605 repeats the range-gate operation cycle a set number of times, and then the flow ends.

### Detection of Multiple Extraneous Lights

The above description refers to cycle specification of extraneous light and the interstitial range-gate imaging operation using a single light source, but this embodiment is not limited to this example. The following description refers to cycle specification of a plurality of extraneous lights and the interstitial range-gate imaging operation.

FIG. 16 illustrates the pixel area 12 divided into a plurality of areas according to this embodiment. As illustrated in FIG. 16, the pixel area 12 is divided into a plurality of areas, and a plurality of divided areas 1200 are set. As described above, the extraneous-light detecting pixels 101b are equally disposed in the plurality of divided areas 1200. In FIG. 16, nine extraneous-light detecting pixels 101b are disposed inside one divided areas 1200, but this embodiment is not limited to this example. The range-gate pixels 101a are omitted in FIG. 16. This embodiment performs determination based on summed extraneous light at a plurality of extraneous-light detecting pixels 101b inside one divided area 1200 (based on the total value of photons received at a plurality of extraneous-light detecting pixels 101b inside one divided areas 1200).

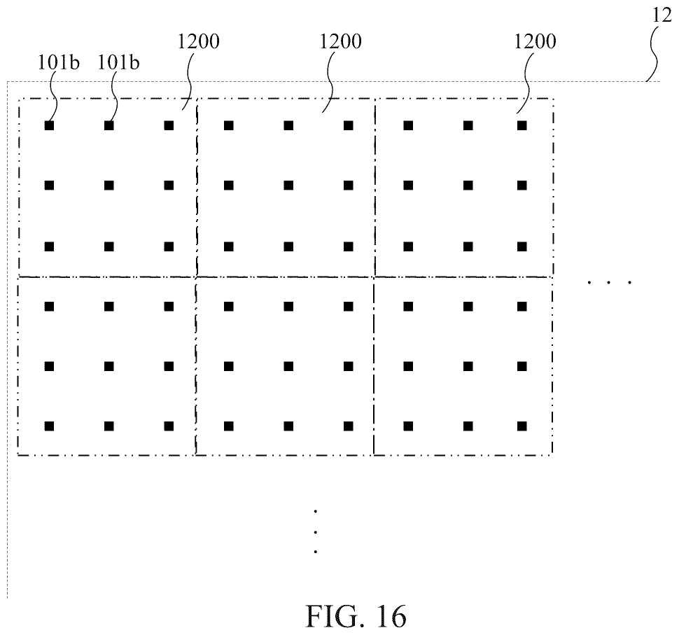

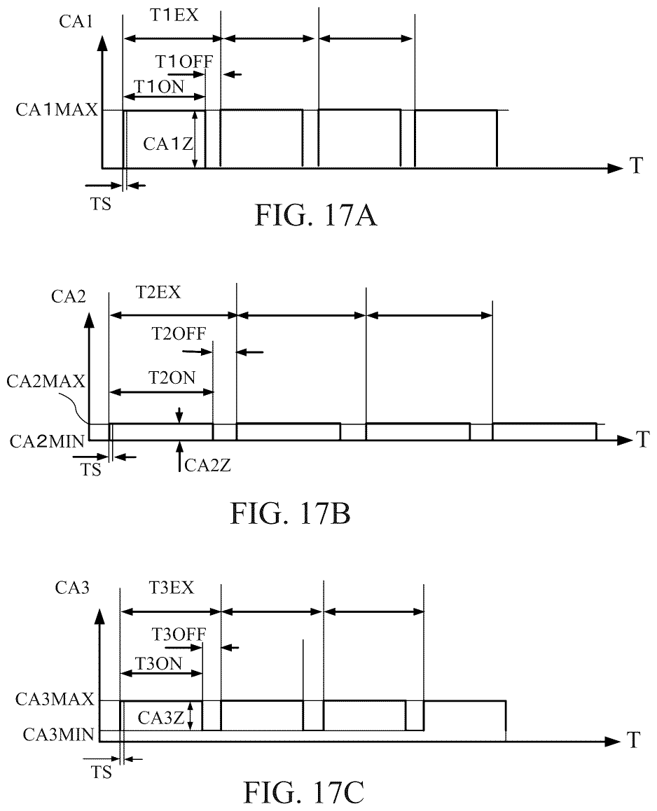

FIGS. 17A, 17B, and 17C are schematic diagrams of an example of the extraneous light amount Ca obtained by summing extraneous light received by the extraneous-light detecting pixels 101b in each divided area 1200, which is detected at the extraneous-light recognition unit 650. In FIG. 17A, a duration T1on of an extraneous light amount maximum value Ca1max in which the light amount of extraneous light is maximum in a cycle T1ex and a duration T1off of an extraneous light amount minimum value Ca1min in which the light amount of extraneous light is minimum are repeated in a divided area 1200. In FIG. 17B, a duration T2on of an extraneous light amount maximum value Ca2max in which the light amount of extraneous light is maximum in a cycle T2ex and a duration T2off of an extraneous light amount maximum value Ca2min in which the light amount of extraneous light is minimum are repeated in a divided area 1200. In FIG. 17C, a duration T3on of an extraneous light amount maximum value Ca3max in which the light amount of extraneous light is maximum in a cycle T3ex and a duration T3off of an extraneous light amount maximum value Ca3min in which the light amount of extraneous light is minimum are repeated in a divided area 1200.

In this embodiment, in a case where a plurality of extraneous light cycles are detected, the extraneous light amount difference Caz, which is the difference between the extraneous light amount maximum value Camax and the extraneous light amount minimum value Camin, is compared among a plurality of extraneous lights. Then, the interstitial range-gate imaging operation is performed during the duration Toff in which the difference is maximum (the first duration of extraneous light in which the maximum light amount difference is obtained). The interstitial range-gate imaging operation is performed during the duration T1off based on the cycle T1ex because of extraneous light amount difference Ca1z>extraneous light amount difference Ca3z>extraneous light amount difference Ca2z in FIGS. 17A, 17B, and 17C.

During the duration Toff in which the extraneous light amount difference Caz is maximum, the duration Toff is short and not suitable for the interstitial range-gate imaging operation in some cases. In such a case, the extraneous light amount differences Caz and durations Toff thus detected may be compared and the interstitial range-gate imaging operation may be performed during the duration Toff in which the interstitial range-gate imaging operation can be performed to obtain an optimum image. A description will now be given with reference to a flowchart.

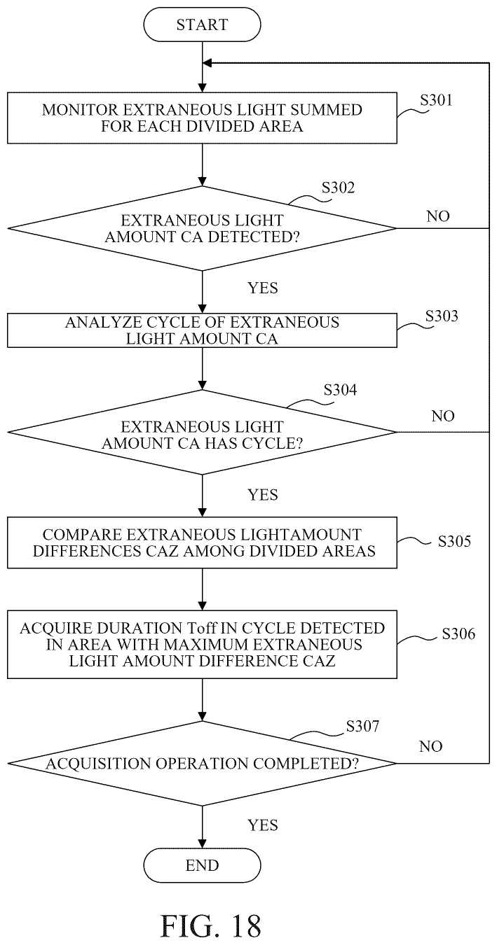

FIG. 18 is the flowchart illustrating cycle specification of a plurality of extraneous lights and acquisition operation of the duration Toff in which the interstitial range-gate imaging operation is performed. The flow starts when the cycle specification operation of extraneous light is executed.

First, in step S301, the extraneous-light recognition unit 650 monitors extraneous light for each divided area 1200. Next, in step S302, in a case where the extraneous light amount Ca is detected by the extraneous-light recognition unit 650, the flow proceeds to step S303. In a case where the extraneous light amount Ca is not detected, the flow returns to step S301.

In step S303, the extraneous-light recognition unit 650 analyzes the cycle of the extraneous light amount Ca. Next, in step S304, the extraneous-light recognition unit 650 determines whether the extraneous light amount Ca has a cycle (first cycle). In a case where it is determined that the extraneous light amount Ca has a cycle, the flow proceeds to step S305. In a case where it is determined that the extraneous light amount Ca does not have a cycle, the flow returns to step S301.

In step S305, the extraneous-light recognition unit 650 compares the extraneous light amount difference Caz among the divided areas. Next, in step S306, the extraneous-light recognition unit 650 specifies (acquires) the duration Toff in which the extraneous light amount difference Caz is maximum. More specifically the extraneous-light recognition unit 650 specifies the duration Toff detected in a divided area where the maximum light amount difference is obtained among the extraneous light amount differences Caz specified in the plurality of divided areas, respectively. Next, in step S307, in a case where the specification operation (acquisition operation) has completed, the flow ends. In a case where the specification operation has not yet completed, the flow returns to step S301.

As described above, the camera control unit 605 acquires, by using the detector, information on the first duration in which the light amount of extraneous light is the first light amount, the second duration in which the light amount is the second light amount larger than the first light amount, a cycle in which the first duration and the second duration are repeated, and the light amount difference between the first light amount and the second light amount. The camera control unit 605 acquires the information based on temporal change in the number of photons received by the extraneous-light detecting pixels 101b. The camera control unit 605 selects information on the first duration in one divided area where the maximum light amount difference is obtained among the light amount differences acquired in the plurality of divided areas 1200, respectively.

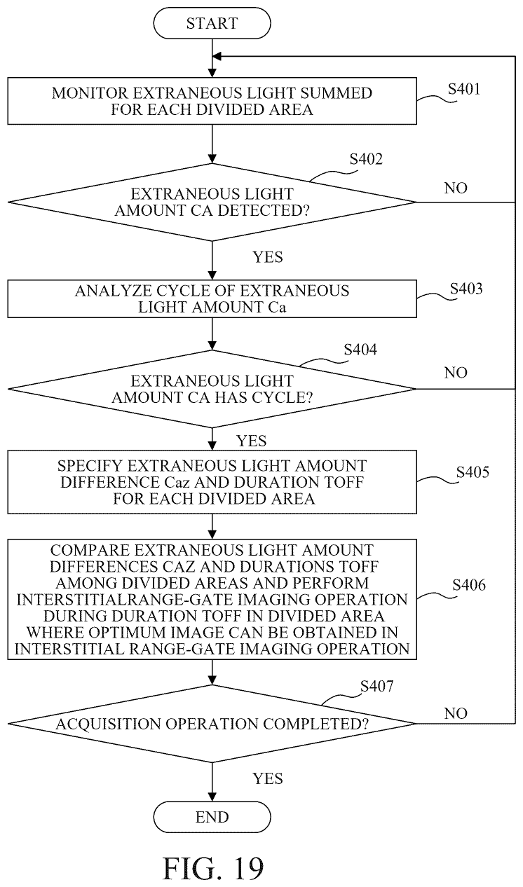

The following describes, as a variation of this embodiment, a cycle specification of a plurality of extraneous lights and specification operation of the duration Toff (first duration) in which the interstitial range-gate imaging operation is performed. FIG. 19 is a flowchart illustrating cycle specification of a plurality of extraneous lights and specification operation of the duration Toff in which the interstitial range-gate imaging operation is performed in this variation.

The flow starts when the cycle specification operation of the extraneous lights is executed. First in step S401, the extraneous-light recognition unit 650 monitors the extraneous light for each divided area 1200. Next, in step S402, the extraneous-light recognition unit 650 determines whether the extraneous light amount Ca is detected. In a case where the extraneous light amount Ca is detected, the flow proceeds to step S403. In a case where the extraneous light amount Ca is not detected, the flow returns to step S401.

In step S403, the extraneous-light recognition unit 650 analyzes the cycle of the extraneous light amount Ca. Next, in step S404, the extraneous-light recognition unit 650 determines whether the extraneous light amount Ca has a cycle (first cycle). In a case where it is determined that the extraneous light amount Ca has a cycle, the flow proceeds to step S405. On the other hand, in a case where it is determined that the extraneous light amount Ca does not have a cycle, the flow returns to step S401.

In step S405, the extraneous-light recognition unit 650 specifies the extraneous light amount difference Caz and the duration Toff for each divided area. Next, in step S406, the extraneous-light recognition unit 650 compares the extraneous light amount difference Caz and the duration Toff among the divided areas and specifies (acquires) the duration Toff in which an optimum image is obtained in the interstitial range-gate imaging operation. For example, as the extraneous light amount difference Caz specified in each of the plurality of divided areas is larger or the duration Toff specified in each of the plurality of divided areas is longer, the priority of the duration Toff to be selected is set to be higher. Next, in step S407, in a case where the specification operation (acquisition operation) has completed, the flow ends. On the other hand, in a case where the specification operation has not yet completed, the flow returns to step S401.

As described above, in this variation, the camera control unit 605 selects information on the first duration in one divided area based on the light amount difference and the second duration acquired in each of the plurality of divided areas 1200.

In the above description of this embodiment, IR light is used to acquire a range-gate image, but this embodiment is not limited to this example. For example, the range-gate image may be acquired by using visible light or light having any other wavelength. Moreover, in the above description, the light source of extraneous light is assumed to be a headlight of a vehicle or the like, but the same effect can be obtained for extraneous light such as a streetlight or a traffic light. Furthermore, in the above description of this embodiment, pixels for detecting extraneous light and pixels for acquisition for performing image recognition are provided in the same photoelectric conversion element 100, but this embodiment is not limited to this example and the pixels may be provided in different photoelectric conversion elements 100 or the like.

In this embodiment, the camera control unit 605 changes the imaging operation in accordance with a detection result of the detector. For example, the camera control unit 605 performs the imaging operation in a case where the light amount of extraneous light is the first light amount (at a first timing), and does not perform the imaging operation in a case where the light amount is the second light amount larger than the first light amount (at a second timing). The camera control unit 605 may control the photoelectric conversion element 100 to perform exposure in a case where the light amount is the first light amount, and control the photoelectric conversion element 100 not to perform exposure in a case where the light amount is the second light amount. However, this embodiment is not limited to control of whether to perform exposure in accordance with the light amount.

For example, the camera control unit 605 may control the photoelectric conversion element 100 to output image data in a case where the light amount is the first light amount, and may control the photoelectric conversion element 100 not to output image data in a case where the light amount is the second light amount. In other words, although exposure is performed irrespective of the light amount, whether to output image data as an exposure result may be changed in accordance with the light amount.

For example, the camera control unit 605 may acquire image data output from the photoelectric conversion element 100 in a case where the light amount is the first light amount, and may not acquire image data output from the photoelectric conversion element 100 in a case where the light amount is the second light amount. In other words, although image data as an exposure result is output irrespective of the light amount, whether to acquire (use) the image data may be changed in accordance with the light amount (image data output from the photoelectric conversion element 100 at a timing at which the light amount is large may be ignored).

For example, the camera control unit 605 may acquire image data (first image data and second image data) output from the photoelectric conversion element 100 irrespective of whether the light amount is the first light amount or the second light amount. In this case, during processing using the first image data and the second image data, the weight of the second image data may be set to be smaller than the weight of the first image data. In a case where some processing is performed by using a plurality of pieces of image data at different timings, the weight of image data obtained at a timing at which the light amount is large is set to be small (for example, the weight is set to zero)

This embodiment can provide a clear range-gate image based on range-gate control with reduced influence of extraneous light.

This embodiment can provide a control apparatus, an image pickup apparatus, a control method, and a storage medium, each of which can perform an imaging operation with reduced influence of extraneous light.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk drive, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority to Japanese Patent Application No. 2024-193279, which was filed on Nov. 1, 2024, and which is hereby incorporated by reference herein in its entirety.

What is claimed is:

1. A control apparatus comprising:
one or more memories storing instructions; and
one or more processors that, upon execution of the instructions, operate to:
detect extraneous light,
perform an imaging operation by synchronizing a light emission timing of a light emitter and an imaging timing of an imaging unit in accordance with a distance to an object, and
change the imaging operation in accordance with a detection result of detecting the extraneous light.

2. The control apparatus according to claim 1, wherein the one or more processors operate to perform the imaging operation in a case where a light amount of the extraneous light is a first light amount, and
wherein the one or more processors operate not to perform the imaging operation in a case where the light amount of the extraneous light is a second light amount larger than the first light amount.

3. The control apparatus according to claim 1, wherein the one or more processors operate to control the imaging unit so as to perform exposure in a case where a light amount of the extraneous light is a first light amount, and
wherein the one or more processors operate to control the imaging unit so as not to perform the exposure in a case where the light amount of the extraneous light is a second light amount larger than the first light amount.

4. The control apparatus according to claim 1, wherein the one or more processors operate to control the imaging unit so as to output image data from the imaging unit in a case where a light amount of the extraneous light is a first light amount, and
wherein the one or more processors operate to control the imaging unit so as not to output the image data from the imaging unit in a case where the light amount of the extraneous light is a second light amount larger than the first light amount.

5. The control apparatus according to claim 1, wherein the one or more processors operate to acquire image data output from the imaging unit in a case where a light amount of the extraneous light is a first light amount, and
wherein the one or more processors operate not to acquire the image data output from the imaging unit in a case where the light amount of the extraneous light is a second light amount larger than the first light amount.

6. The control apparatus according to claim 1, wherein the one or more processors operate to:
acquire first image data output from the imaging unit in a case where a light amount of the extraneous light is a first light amount,
acquire second image data output from the imaging unit in a case where the light amount of the extraneous light is a second light amount larger than the first light amount, and
set a weight of the second image data to be smaller than a weight of the first image data for processing that uses the first image data and the second image data.

7. The control apparatus according to claim 1, wherein the extraneous light is cyclic light having a first duration and a second duration,
wherein a light amount in the first duration is a first light amount, and
wherein a light amount in the second duration is a second light amount larger than the first light amount.

8. The control apparatus according to claim 1, wherein the extraneous light is light that is not caused by light emission of the light emitter.

9. An image pickup apparatus comprising:
a control apparatus; and
the imaging unit,
wherein the control apparatus includes:
one or more memories storing instructions; and
one or more processors that, upon execution of the instructions, operate to:
detect extraneous light,
perform an imaging operation by synchronizing a light emission timing of a light emitter and an imaging timing of an imaging unit in accordance with a distance to an object, and
change the imaging operation in accordance with a detection result of detecting the extraneous light.

10. The image pickup apparatus according to claim 9, wherein the imaging unit includes:
a sensor portion configured to emit pulses in accordance with a photon reception frequency,
a counter circuit configured to count the number of pulses,
a memory circuit configured to store a count value by the counter circuit,
a plurality of pixel portions, and
a generator configured to generate a count enable signal for controlling counting of the counter circuit, and
wherein the one or more processors operate to perform synchronization control of the count enable signal and the light emission timing in accordance with the distance.

11. The image pickup apparatus according to claim 10, wherein the plurality of pixel portions include:
a first pixel portion configured to receive reflected light of light emitted from the light emitter, and
a second pixel portion configured to receive the extraneous light.

12. The image pickup apparatus according to claim 11, wherein the second pixel portion is smaller than the first pixel portion.

13. The image pickup apparatus according to claim 11, wherein the one or more processors operate to acquire:
a first duration in which a light amount of the extraneous light is a first light amount,
a second duration in which the light amount of the extraneous light is a second light amount larger than the first light amount,
a cycle in which the first duration and the second duration are repeated, and
information on a light amount difference between the first light amount and the second light amount.

14. The image pickup apparatus according to claim 13, wherein the one or more processors operate to acquire the information based on a temporal change in the number of photons received by the second pixel portion.

15. The image pickup apparatus according to claim 13, wherein the imaging unit includes a plurality of divided areas,
wherein each of the plurality of divided areas includes the first pixel portion and the second pixel portion, and
wherein in each of the plurality of divided areas, the information is acquired based on a total value of photons received by the second pixel portion.

16. The image pickup apparatus according to claim 15, wherein the one or more processors operate to select the information on the first duration in one divided area in which a maximum light amount difference among light amount differences acquired in the plurality of respective divided areas is acquired.

17. The image pickup apparatus according to claim 15, wherein the one or more processors operate to select the information on the first duration in one divided area based on light amount differences acquired in the plurality of respective divided areas and the second duration.

18. A control method comprising:
detecting extraneous light,
performing an imaging operation by synchronizing a light emission timing of a light emitter and an imaging timing of an imaging unit in accordance with a distance to an object, and
changing the imaging operation in accordance with a detection result of detecting the extraneous light.

19. A non-transitory computer-readable storage medium storing a computer program that causes a computer to execute the control method according to claim 18.
